(19) United States
(12) Patent Application Publication
(10) Pub. No.: US 2022/0358093 A1
(43) Pub. Date: Nov. 10, 2022

(54) COMPRESSION TECHNIQUES FOR SHARED FILES

(71) Applicant: Citrix Systems, Inc., Fort Lauderdale, FL (US)

(72) Inventors: Venkata Naga Maheshwar Damojipurapu, Bangalore (IN); Muhammad Dawood, High Wycombe (GB)

(21) Appl. No.: 17/314,841

(22) Filed: May 7, 2021

(51) Int. Cl. G06F 16/174; G06F 21/56; H03M 7/30

(52) U.S. Cl. CPC G06F 16/1744; G06F 21/565; H03M 7/607; G06F 2221/034

(57) ABSTRACT

A computing system may receive, from a client device, data associated with a file to be uploaded to the computing system, and may determine, based at least in part on the received data, a recommended compression technique to be used on the file. The computing system may send an indication of the recommended compression technique to the client device. The computing system may receive, from the client device, a version of the file that is compressed in accordance with the recommended compression technique.

### BACKGROUND

Various file sharing systems have been developed that allow users to share files or other data. ShareFile®, offered by Citrix Systems, Inc., of Fort Lauderdale, Fla., is one example of such a file sharing system.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves receiving, by a computing system and from a client device, first data associated with a first file to be uploaded to the computing system, determining, by the computing system and based at least in part on the first data, a recommended compression technique to be used on the first file, sending, from the computing system to the client device, an indication of the recommended compression technique, and receiving, by the computing system and from the client device, a version of the first file that is compressed in accordance with the recommended compression technique.

In some disclosed embodiments, a computing system may comprise at least one processor and at least one computer-readable medium encoded with instructions which, when executed by the at least one processor, cause the computing system to receive, from a client device, first data associated with a first file to be uploaded to the computing system, determine, based at least in part on the first data, a recommended compression technique to be used on the first file, send, to the client device, an indication of the recommended compression technique, and receive, from the client device, a version of the first file that is compressed in accordance with the recommended compression technique.

In some disclosed embodiments, at least one non-transitory computer-readable medium may be encoded with instructions which, when executed by at least one processor included in a computing system, cause the computing system to receive, from a client device, first data associated with a first file to be uploaded to the computing system, determine, based at least in part on the first data, a recommended compression technique to be used on the first file, send, to the client device, an indication of the recommended compression technique, and receive, from the client device, a version of the first file that is compressed in accordance with the recommended compression technique.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1 is a diagram illustrating how a system may determine a recommended compression technique for a file to be uploaded to a computing system in accordance with the present disclosure;

FIG. 2 is a diagram of a network environment in which some embodiments of the present disclosure may be deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a diagram illustrating how a network computing environment like one shown in FIG. 2 may be configured to allow clients access to an example embodiment of a file sharing system;

FIG. 5B is a diagram illustrating certain operations that may be performed by the file sharing system shown in FIG. 5A in accordance with some embodiments;

FIG. 5C is a diagram illustrating additional operations that may be performed by the file sharing system shown in FIG. 5A in accordance with some embodiments;

FIG. 6A shows example components of the computing system shown in FIG. 1;

FIG. 6B shows example components of the client device shown in FIG. 1;

FIGS. 7A and 7B show example routines that may be performed by the client device shown in 6B in accordance with some embodiments;

FIG. 8 shows an example routine that may be performed by the computing system shown in FIG. 6A to determine a recommended compression technique using one or more rules in accordance with some embodiments;

FIG. 9 shows an example routine that may be performed by the computing system shown in FIG. 6A to determine a recommended compression technique using a reference file in accordance with some embodiments;

FIG. 10 shows an example routine that may be performed by the computing system shown in FIG. 6A to recommend where a compression technique is to be applied in accordance with some embodiments;

FIG. 11 shows an example routine that may be performed by the computing system shown in FIG. 6A to determine a recommended compression technique using simulations in accordance with some embodiments;

FIG. 12 shows an example routine that may be performed by the computing system shown in FIG. 6A to determine to a storage technique for an identical file to be uploaded in accordance with some embodiments; and

FIG. 13 shows an example routine that may be performed by the computing system shown in FIG. 6A to determine to a storage technique for a version of a file to be uploaded in accordance with some embodiments.

### DETAILED DESCRIPTION

For purposes of reading the description of the various embodiments below, the following descriptions of the sections of the specification and their respective contents may be helpful:

Section A provides an introduction to example embodiments of a compression technique recommendation system for shared files;

Section B describes a network environment which may be useful for practicing embodiments described herein;

Section C describes a computing system which may be useful for practicing embodiments described herein.

Section D describes embodiments of systems and methods for delivering shared resources using a cloud computing environment;

Section E describes example embodiments of systems for providing file sharing over networks;

Section F provides a more detailed description of example embodiments of the compression technique recommendation system for shared files introduced above in Section A; and

Section G describes example implementations of methods, systems/devices, and computer-readable media in accordance with the present disclosure.

### A. Introduction to Illustrative Embodiments of a Compression Technique Recommendation System for Shared Files

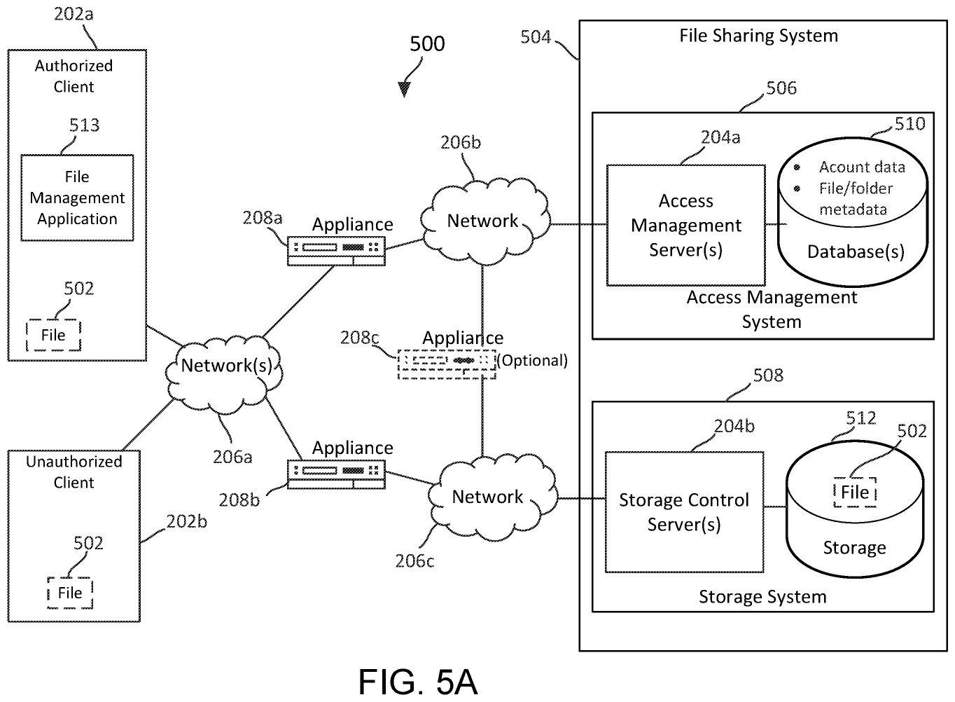

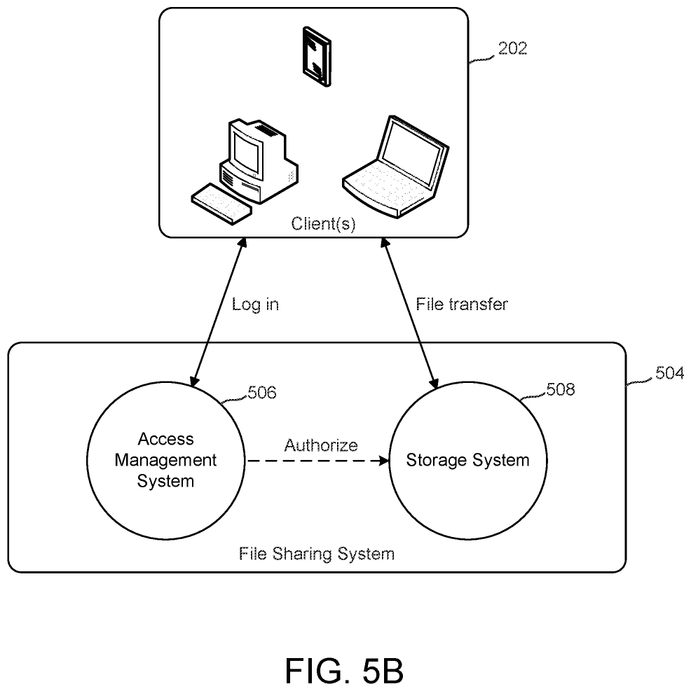

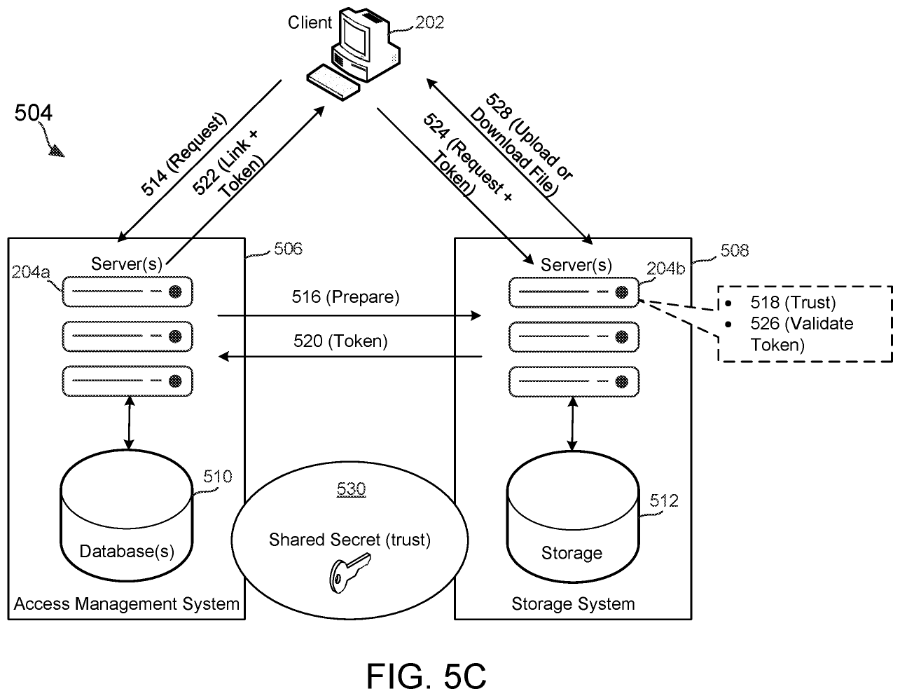

Various file sharing systems have been developed that allow users to share files with other users over a network. An example of such a file sharing system 504 is described below (in Section E) in connection with FIGS. 5A-C. As explained in Section E, in some implementations, one client device 202 may upload a file 502 (shown in FIG. 5A) to a central repository of the file sharing system 504, such as the storage system 512 shown in FIGS. 5A-C, and another client device 202 may then download a copy of that file 502 from the same repository. As Section E also describes, in some implementations, an access management system 506 may regulate the circumstances in which files 502 may be uploaded and/or downloaded to/from the storage system 508 by various client devices 202.

In some implementations, the file sharing system 504 may be implemented in a cloud computing environment. There is typically a monetary cost associated with storing data in such an environment. Generally, the cost increases with the amount of data that is stored. One of the techniques for transferring and/or storing files may involve compressing the file. However, compression and decompression of data in a cloud computing environment may be expensive in terms of computational resources (e.g., processor(s) and memory) needed to perform the compression and decompression, processing time needed to perform the compression and decompression, and the monetary cost for using the computational resources in the cloud to perform the compression and decompression.

The inventors have recognized and appreciated that there is a need to reduce costs with storing data in a remote computing system, such as a cloud computing environment. Offered are systems and techniques for determining an optimal compression technique for a file to be uploaded to a remote computing system (e.g., the file sharing system 504).

In some implementations, the system may select a compression technique, from various compression techniques, based on one or more aspects of the file that is to be uploaded. Selection of a compression technique may, for example, be based on the file type (e.g., text file, pdf, Word document, computer aided design (CAD) file, audio file, video file, image file, etc.) and/or a file size of the file to be uploaded. The type of a given file may be determined, for example, based on the extension (e.g., .txt, .pdf, .docx, etc.) appended to the name of the file. In some implementations, the system may select a compression technique that was previously used to compress a reference file, based on the to-be-uploaded file being similar to the reference file.

In some implementations, the system may additionally or alternatively recommend whether the file should be compressed at the client device 202, prior to sending it to the remote computing system, or whether the file should instead be compressed at the remote computing system.

In some implementations, the system may additionally or alternatively run simulations, using different compression techniques, on a sampling of data from the file, to recommend an optimal compression technique to apply to the file.

In some implementations, the system may additionally or alternatively determine one or more metrics related to using a particular compression technique to compress the file. For example, the system may estimate a reduction in size of the file if the recommended compression technique is used. As a further example, the system may estimate an amount of time it may take to compress the file using the recommended compression technique. As yet a further example, the system may estimate a monetary cost for using the recommended compression technique to compress the file at the remote computing system.

Examples of compression techniques that the system may recommend include, but are not limited to, lossless data compression techniques, lossy data compression techniques, audio data compression techniques, image data compression techniques, text data compression techniques, LZ77 compression techniques, LZR compression techniques, Lempel-Ziv-Storer-Szymanski (LZSS) compression techniques, DEFLATE compression techniques, Lempel-Ziv Markov chain Algorithm (LZMA) compression techniques, LZMA2 compression techniques, multi-layer perception (MLP)-Based compression techniques, deep neural network (DNN) based compression techniques, convolutional neural network (CNN) based compression techniques, generative adversarial network (GAN) based compression techniques, Huffman compression techniques, JPEG compression techniques, run length encoding (RLE) compression techniques, a stream-based compression techniques, and a real-time history-based byte stream compression with mirrored encoder decoder context-based Huffman symbol code computation (e.g., as described U.S. Pat. No. 10,651,871, the entire contents of which are incorporated herein by reference).

In recommending a compression technique, the system may also recommend an application to generate a compressed version of the file using the recommended compression technique.

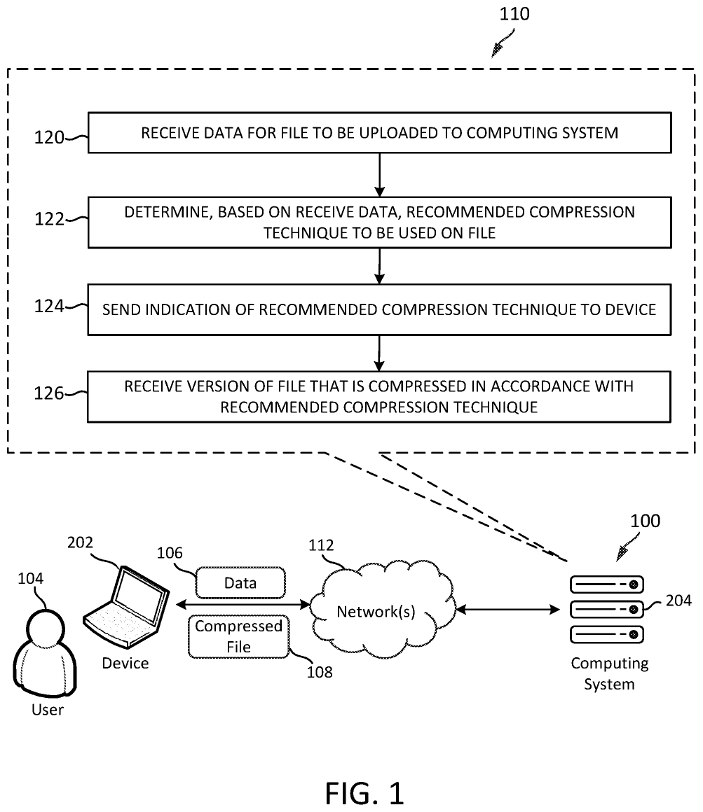

FIG. 1 is a diagram illustrating how a computing system 100 may determine a compression technique for a file to be uploaded from a client device 202 to the computing system 100. In some embodiments, computing system 100 may, for example, be included within, or may operate in conjunction with, the file sharing system 504 described in Section E below in connection with FIGS. 5-C. In some embodiments, the computing system 100 may be embodied by one or more servers 204 (such as the storage control server(s) 204b shown in FIGS. 5A and 5C). The client device 202 (e.g., one of the client device(s) 202 shown in FIGS. 5A-C) may be in communication with the computing system 100 using one or more networks 112 (such as the network(s) 206 shown in FIG. 5A).

In some implementations, a file sharing application (e.g., the file management application 513 shown in FIG. 5A) may be installed on the client device 202, and a user 104 may use the file sharing application to upload a file to the computing system 100. In some implementations, the user 104 may use a browser-based file sharing application to upload a file to the computing system 100. As shown in FIG. 1, in some implementations, the computing system 100 may be configured to perform a process 110 to determine a compression technique for the file that is to be uploaded to the computing system 100.

The file sharing application, at the client device 202, may determine data 106 for the file that is to be uploaded. The data 106 may, for example, include tags associated with the file, a filename, a file type, a file size, a username of the user 104, and/or a sampling of data from the file. At a step 120 (shown in FIG. 1) of the process 110, the computing system 100 may receive, from the client device 202, the data 106 for the file to be uploaded to the computing system 100.

At a step 122 of the process 110, the computing system 100 may determine, based on the received data 106, a recommended compression technique to be used on the file. In some implementations, the computing system 100 may use a table or another data structure that stores information on which compression technique is to be used for a particular file type, a particular file size, or a combination of a particular file type and particular file size. In some implementations, the computing system 100 may additionally or alternatively use a rule-based engine to determine the recommended compression technique for the file. Such a rule-based engine may include one or more rules specifying a compression technique for a particular file type, a particular file size, or a combination of a particular file type and particular file size. In some implementations the particular file size may be indicated as a single value (e.g., 8 MB, 1 GB, etc.), and in other implementations the particular file size may be indicated as a range (e.g., less than 8 MB, more than 8 MB, between 8 MB and 10 MB, etc.).

In some implementations, the computing system 100 may additionally or alternatively use a reference file, similar to the file to be uploaded, to determine the recommended compression technique. In such implementations, the computing system 100 may identify the reference file using the data 106, where the reference file may be similar to the file to be uploaded. The computing system 100 may identify the reference file, for example, based on matching one or more of a filename, a file type, a file size and/or a username associated with the reference file with one or more of the filename, the file type, the file size and/or the username of the user 104 associated with the file to be uploaded. In some implementations, the computing system 100 may use one or more machine learning models to identify the reference file. The reference file may be a file that is already uploaded at the computing system 100 in a compressed form. In some embodiments, the reference file may instead be stored, in a compressed form, at a computing system or database that is separate from the computing system 100. In some implementations, the reference file may be associated with a tag indicating a compression technique that was used to compress the reference file. The computing system 100 may determine the recommended compression technique based on the compression technique that was used to compress the reference file.

In some implementations, the data 106 may include a sampling of the contents of the payload of the file, and the computing system 100 may additionally or alternatively run various compression algorithms on that sampling of data to determine a compression algorithm that is likely to result in the most optimal compression result for the entirety of the file.

At a step 124 of the process 110, the computing system 100 may send an indication of the recommended compression technique to the client device 202. The indication may, for example, include a name of the recommended compression technique. Sending of the indication may cause the client device 202 to display the name of the recommended compression technique via the file sharing application. In some embodiments, the client device 202 may also display a graphical user interface (GUI) element, selection of which, by the user 104, may cause the client device 202 to generate a version of the file in accordance with the recommended compression technique (e.g., as a compressed file 108). The client device 202 may send the compressed file 108 to the computing system 100 for upload. At a step 126, the computing system 100 may receive the version of the file (e.g., the compressed file 108) that is compressed in accordance with the recommended compression technique. In some implementations, the computing system 100 may store the compressed file 108, in its compressed form, in one or more repositories (e.g., in the storage medium(s) 512 shown in FIGS. 5A and 5C). In some implementations, the computing system 100 may additionally or alternatively un-compress the compressed file 108 prior to storing it in one or more repositories.

In some implementations, rather than recommending a compression technique to the client device 202, the computing system 100 may, at least in certain circumstances, instead recommend that the client device 202 not compress the file. For example, the computing system 100 may determine to recommend not compressing a file if the size of the file is below a certain threshold value, or if the file is of a particular type where the contents are already compressed (e.g., a JPEG file).

In this manner, the computing system 100 may determine an optimal compression technique for use in uploading a file. Additional details and example implementations of embodiments of the present disclosure are set forth below in Section F, following a description of example systems and network environments in which such embodiments may be deployed.

### B. Network Environment

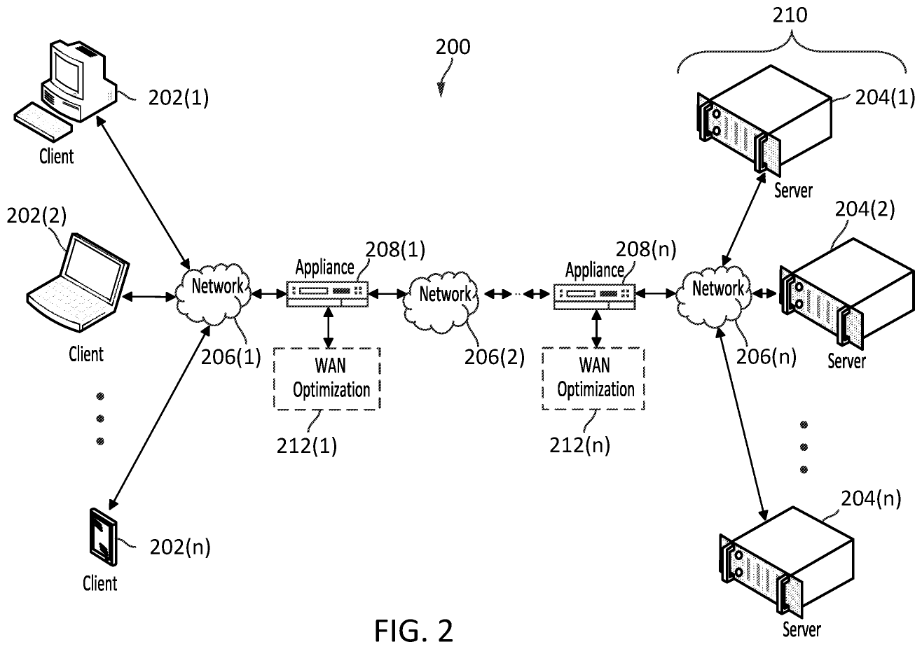

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), interne protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+an organization.

### C. Computing Environment

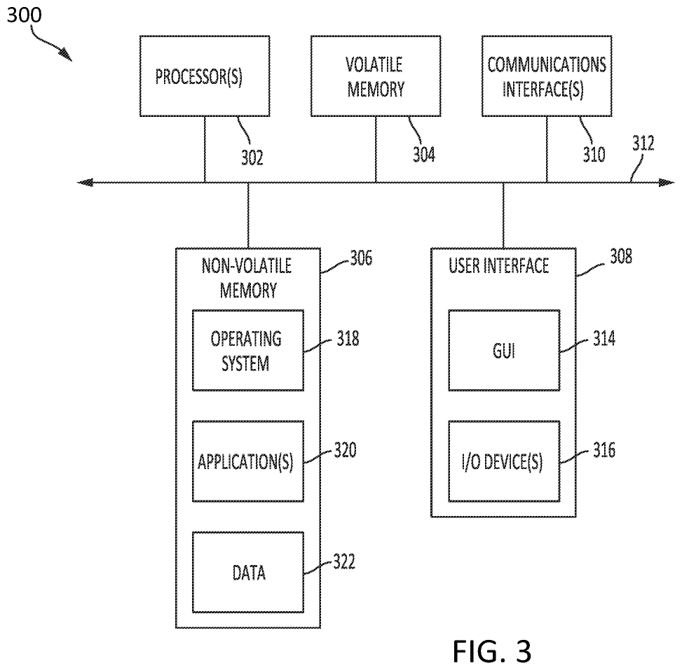

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

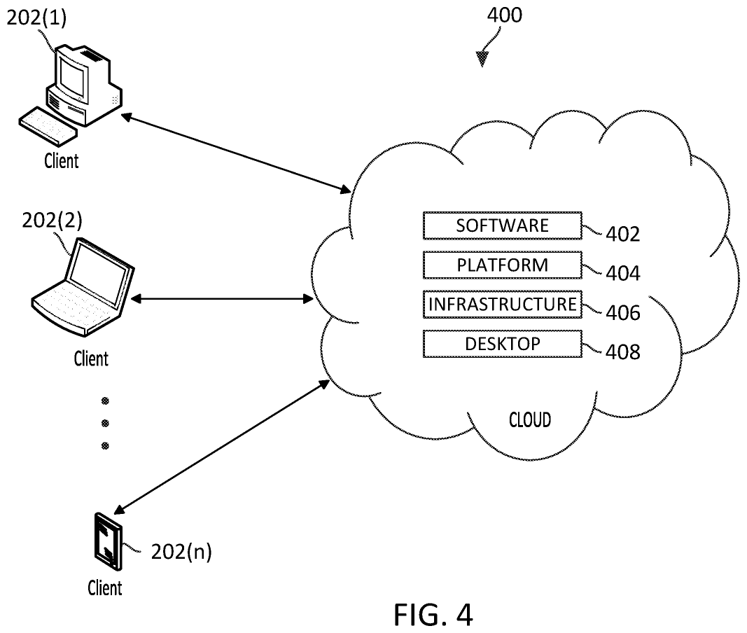

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Systems and Methods for Providing File Sharing Over Network(s)

FIG. 5A shows an example network environment 500 for allowing an authorized client 202a and/or an unauthorized client 202b to upload a file 502 to a file sharing system 504 or download a file 502 from the file sharing system 504. The authorized client 202a may, for example, be a client 202 operated by a user having an active account with the file sharing system 504, while the unauthorized client 202b may be operated by a user who lacks such an account. As shown, in some embodiments, the authorized client 202a may include a file management application 513 with which a user of the authorized client 202a may access and/or manage the accessibility of one or more files 502 via the file sharing system 504. The file management application 513 may, for example, be a mobile or desktop application installed on the authorized client 202a (or in a computing environment accessible by the authorized client). The ShareFile° mobile app and the ShareFile® desktop app offered by Citrix Systems, Inc., of Fort Lauderdale, Fla., are examples of such preinstalled applications. In other embodiments, rather than being installed on the authorized client 202a, the file management application 513 may be executed by a web server (included with the file sharing system 504 or elsewhere) and provided to the authorized client 202a via one or more web pages.

As FIG. 5A illustrates, in some embodiments, the file sharing system 504 may include an access management system 506 and a storage system 508. As shown, the access management system 506 may include one or more access management servers 204a and a database 510, and the storage system 508 may include one or more storage control servers 204b and a storage medium 512. In some embodiments, the access management server(s) 204a may, for example, allow a user of the file management application 513 to log in to his or her account, e.g., by entering a user name and password corresponding to account data stored in the database 510. Once the user of the client 202a has logged in, the access management server 204a may enable the user to view (via the authorized client 202a) information identifying various folders represented in the storage medium 512, which is managed by the storage control server(s) 204b, as well as any files 502 contained within such folders. File/folder metadata stored in the database 510 may be used to identify the files 502 and folders in the storage medium 512 to which a particular user has been provided access rights.

In some embodiments, the clients 202a, 202b may be connected to one or more networks 206a (which may include the Internet), the access management server(s) 204a may include webservers, and an appliance 208a may load balance requests from the authorized client 202a to such webservers. The database 510 associated with the access management server(s) 204a may, for example, include information used to process user requests, such as user account data (e.g., username, password, access rights, security questions and answers, etc.), file and folder metadata (e.g., name, description, storage location, access rights, source IP address, etc.), and logs, among other things. Although the clients 202a, 202b are shown is FIG. 5A as stand-alone computers, it should be appreciated that one or both of the clients 202a, 202b shown in FIG. 5A may instead represent other types of computing devices or systems that can be operated by users. In some embodiments, for example, one or both of the authorized client 202a and the unauthorized client 202b may be implemented as a server-based virtual computing environment that can be remotely accessed using a separate computing device operated by users, such as described above.

In some embodiments, the access management system 506 may be logically separated from the storage system 508, such that files 502 and other data that are transferred between clients 202 and the storage system 508 do not pass through the access management system 506. Similar to the access management server(s) 204a, one or more appliances 208b may load-balance requests from the clients 202a, 202b received from the network(s) 206a (which may include the Internet) to the storage control server(s) 204b. In some embodiments, the storage control server(s) 204b and/or the storage medium 512 may be hosted by a cloud-based service provider (e.g., Amazon Web Services™ or Microsoft Azure™). In other embodiments, the storage control server(s) 204b and/or the storage medium 512 may be located at a data center managed by an enterprise of a client 202, or may be distributed among some combination of a cloud-based system and an enterprise system, or elsewhere.

After a user of the authorized client 202a has properly logged in to an access management server 204a, the server 204a may receive a request from the client 202a for access to one of the files 502 or folders to which the logged in user has access rights. The request may either be for the authorized client 202a to itself to obtain access to a file 502 or folder or to provide such access to the unauthorized client 202b. In some embodiments, in response to receiving an access request from an authorized client 202a, the access management server 204a may communicate with the storage control server(s) 204b (e.g., either over the Internet via appliances 208a and 208b or via an appliance 208c positioned between networks 206b and 206c) to obtain a token generated by the storage control server 204b that can subsequently be used to access the identified file 502 or folder.

In some implementations, the generated token may, for example, be sent to the authorized client 202a, and the authorized client 202a may then send a request for a file 502, including the token, to the storage control server(s) 204b. In other implementations, the authorized client 202a may send the generated token to the unauthorized client 202b so as to allow the unauthorized client 202b to send a request for the file 502, including the token, to the storage control server(s) 204b. In yet other implementations, an access management server 204a may, at the direction of the authorized client 202a, send the generated token directly to the unauthorized client 202b so as to allow the unauthorized client 202b to send a request for the file 502, including the token, to the storage control server(s) 204b. In any of the forgoing scenarios, the request sent to the storage control server(s) 204b may, in some embodiments, include a uniform resource locator (URL) that resolves to an internet protocol (IP) address of the storage control server(s) 204b, and the token may be appended to or otherwise accompany the URL. Accordingly, providing access to one or more clients 202 may be accomplished, for example, by causing the authorized client 202a to send a request to the URL address, or by sending an email, text message or other communication including the token-containing URL to the unauthorized client 202b, either directly from the access management server(s) 204a or indirectly from the access management server(s) 204a to the authorized client 202a and then from the authorized client 202a to the unauthorized client 202b. In some embodiments, selecting the URL or a user interface element corresponding to the URL, may cause a request to be sent to the storage control server(s) 204b that either causes a file 502 to be downloaded immediately to the client that sent the request, or may cause the storage control server 204b to return a webpage to the client that includes a link or other user interface element that can be selected to effect the download.

In some embodiments, a generated token can be used in a similar manner to allow either an authorized client 202a or an unauthorized client 202b to upload a file 502 to a folder corresponding to the token. In some embodiments, for example, an “upload” token can be generated as discussed above when an authorized client 202a is logged in and a designated folder is selected for uploading. Such a selection may, for example, cause a request to be sent to the access management server(s) 204a, and a webpage may be returned, along with the generated token, that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In some embodiments, sending a request including such a token to the storage control server(s) 204b (e.g., by selecting a URL or user-interface element included in an email inviting the user to upload one or more files 502 to the file sharing system 504), a webpage may be returned that permits the user to drag and drop one or more files 502 into a designated region and then select a user interface element to effect the upload. The resulting communication to the storage control server(s) 204b may include both the to-be-uploaded file(s) 502 and the pertinent token. On receipt of the communication, a storage control server 204b may cause the file(s) 502 to be stored in a folder corresponding to the token.

In the described embodiments, the clients 202, servers 204, and appliances 208 and/or 212 (appliances 212 are shown in FIG. 2) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may correspond to respective computing systems, groups of computing systems, or networks of distributed computing systems, such as computing system 300 shown in FIG. 3.

As discussed above in connection with FIG. 5A, in some embodiments, a file sharing system may be distributed between two sub-systems, with one subsystem (e.g., the access management system 506) being responsible for controlling access to files 502 stored in the other subsystem (e.g., the storage system 508). FIG. 5B illustrates conceptually how one or more clients 202 may interact with two such subsystems.

As shown in FIG. 5B, an authorized user operating a client 202, which may take on any of numerous forms, may log in to the access management system 506, for example, by entering a valid user name and password. In some embodiments, the access management system 506 may include one or more webservers that respond to requests from the client 202. The access management system 506 may store metadata concerning the identity and arrangements of files 502 (shown in FIG. 5A) stored by the storage system 508, such as folders maintained by the storage system 508 and any files 502 contained within such folders. In some embodiments, the metadata may also include permission metadata identifying the folders and files 502 that respective users are allowed to access. Once logged in, a user may employ a user-interface mechanism of the client 202 to navigate among folders for which the metadata indicates the user has access permission.

In some embodiments, the logged-in user may select a particular file 502 the user wants to access and/or to which the logged-in user wants a different user of a different client 202 to be able to access. Upon receiving such a selection from a client 202, the access management system 506 may take steps to authorize access to the selected file 502 by the logged-in client 202 and/or the different client 202. In some embodiments, for example, the access management system 506 may interact with the storage system 508 to obtain a unique “download” token which may subsequently be used by a client 202 to retrieve the identified file 502 from the storage system 508. The access management system 506 may, for example, send the download token to the logged-in client 202 and/or a client 202 operated by a different user. In some embodiments, the download token may a single-use token that expires after its first use.

In some embodiments, the storage system 508 may also include one or more webservers and may respond to requests from clients 202. In such embodiments, one or more files 502 may be transferred from the storage system 508 to a client 202 in response to a request that includes the download token. In some embodiments, for example, the download token may be appended to a URL that resolves to an IP address of the webserver(s) of the storage system 508. Access to a given file 502 may thus, for example, be enabled by a “download link” that includes the URL/token. Such a download link may, for example, be sent the logged-in client 202 in the form of a “DOWNLOAD” button or other user-interface element the user can select to effect the transfer of the file 502 from the storage system 508 to the client 202. Alternatively, the download link may be sent to a different client 202 operated by an individual with which the logged-in user desires to share the file 502. For example, in some embodiments, the access management system 506 may send an email or other message to the different client 202 that includes the download link in the form of a “DOWNLOAD” button or other user-interface element, or simply with a message indicating “Click Here to Download” or the like. In yet other embodiments, the logged-in client 202 may receive the download link from the access management system 506 and cut-and-paste or otherwise copy the download link into an email or other message the logged in user can then send to the other client 202 to enable the other client 202 to retrieve the file 502 from the storage system 508.

In some embodiments, a logged-in user may select a folder on the file sharing system to which the user wants to transfer one or more files 502 (shown in FIG. 5A) from the logged-in client 202, or to which the logged-in user wants to allow a different user of a different client 202 to transfer one or more files 502. Additionally or alternatively, the logged-in user may identify one or more different users (e.g., by entering their email addresses) the logged-in user wants to be able to access one or more files 502 currently accessible to the logged-in client 202.

Similar to the file downloading process described above, upon receiving such a selection from a client 202, the access management system 506 may take steps to authorize access to the selected folder by the logged-in client 202 and/or the different client 202. In some embodiments, for example, the access management system 506 may interact with the storage system 508 to obtain a unique “upload token” which may subsequently be used by a client 202 to transfer one or more files 502 from the client 202 to the storage system 508. The access management system 506 may, for example, send the upload token to the logged-in client 202 and/or a client 202 operated by a different user.

One or more files 502 may be transferred from a client 202 to the storage system 508 in response to a request that includes the upload token. In some embodiments, for example, the upload token may be appended to a URL that resolves to an IP address of the webserver(s) of the storage system 508. For example, in some embodiments, in response to a logged-in user selecting a folder to which the user desires to transfer one or more files 502 and/or identifying one or more intended recipients of such files 502, the access management system 506 may return a webpage requesting that the user drag-and-drop or otherwise identify the file(s) 502 the user desires to transfer to the selected folder and/or a designated recipient. The returned webpage may also include an “upload link,” e.g., in the form of an “UPLOAD” button or other user-interface element that the user can select to effect the transfer of the file(s) 502 from the client 202 to the storage system 508.

In some embodiments, in response to a logged-in user selecting a folder to which the user wants to enable a different client 202 operated by a different user to transfer one or more files 502, the access management system 506 may generate an upload link that may be sent to the different client 202. For example, in some embodiments, the access management system 506 may send an email or other message to the different client 202 that includes a message indicating that the different user has been authorized to transfer one or more files 502 to the file sharing system, and inviting the user to select the upload link to effect such a transfer. Section of the upload link by the different user may, for example, generate a request to webserver(s) in the storage system and cause a webserver to return a webpage inviting the different user to drag-and-drop or otherwise identify the file(s) 502 the different user wishes to upload to the file sharing system 504. The returned webpage may also include a user-interface element, e.g., in the form of an “UPLOAD” button, that the different user can select to effect the transfer of the file(s) 502 from the client 202 to the storage system 508. In other embodiments, the logged-in user may receive the upload link from the access management system 506 and may cut-and-paste or otherwise copy the upload link into an email or other message the logged-in user can then send to the different client 202 to enable the different client to upload one or more files 502 to the storage system 508.

In some embodiments, in response to one or more files 502 being uploaded to a folder, the storage system 508 may send a message to the access management system 506 indicating that the file(s) 502 have been successfully uploaded, and an access management system 506 may, in turn, send an email or other message to one or more users indicating the same. For user's that have accounts with the file sharing system 504, for example, a message may be sent to the account holder that includes a download link that the account holder can select to effect the transfer of the file 502 from the storage system 508 to the client 202 operated by the account holder. Alternatively, the message to the account holder may include a link to a webpage from the access management system 506 inviting the account holder to log in to retrieve the transferred files 502. Likewise, in circumstances in which a logged-in user identifies one or more intended recipients for one or more to-be-uploaded files 502 (e.g., by entering their email addresses), the access management system 506 may send a message including a download link to the designated recipients (e.g., in the manner described above), which such designated recipients can then use to effect the transfer of the file(s) 502 from the storage system 508 to the client(s) 202 operated by those designated recipients.

FIG. 5C is a block diagram showing an example of a process for generating access tokens (e.g., the upload tokens and download tokens discussed above) within the file sharing system 504 described in connection with FIGS. 5A and 5B.

As shown, in some embodiments, a logged-in client 202 may initiate the access token generation process by sending an access request 514 to the access management server(s) 204b. As noted above, the access request 514 may, for example, correspond to one or more of (A) a request to enable the downloading of one or more files 502 (shown in FIG. 5A) from the storage system 508 to the logged-in client 202, (B) a request to enable the downloading of one or more files 502 from the storage system 508 to a different client 202 operated by a different user, (C) a request to enable the uploading of one or more files 502 from a logged-in client 202 to a folder on the storage system 508, (D) a request to enable the uploading of one or more files 502 from a different client 202 operated by a different user to a folder of the storage system 508, (E) a request to enable the transfer of one or more files 502, via the storage system 508, from a logged-in client 202 to a different client 202 operated by a different user, or (F) a request to enable the transfer of one or more files 502, via the storage system 508, from a different client 202 operated by a different user to a logged-in client 202.

In response to receiving the access request 514, an access management server 204a may send a “prepare” message 516 to the storage control server(s) 204b of the storage system 508, identifying the type of action indicated in the request, as well as the identity and/or location within the storage medium 512 of any applicable folders and/or files 502. As shown, in some embodiments, a trust relationship may be established (step 518) between the storage control server(s) 204b and the access management server(s) 204a. In some embodiments, for example, the storage control server(s) 204b may establish the trust relationship by validating a hash-based message authentication code (HMAC) based on shared secret or key 530).

After the trust relationship has been established, the storage control server(s) 204b may generate and send (step 520) to the access management server(s) 204a a unique upload token and/or a unique download token, such as those as discussed above.

After the access management server(s) 204a receive a token from the storage control server(s) 204b, the access management server(s) 204a may prepare and send a link 522 including the token to one or more client(s) 202. In some embodiments, for example, the link may contain a fully qualified domain name (FQDN) of the storage control server(s) 204b, together with the token. As discussed above, the link 522 may be sent to the logged-in client 202 and/or to a different client 202 operated by a different user, depending on the operation that was indicated by the request.

The client(s) 202 that receive the token may thereafter send a request 524 (which includes the token) to the storage control server(s) 204b. In response to receiving the request, the storage control server(s) 204b may validate (step 526) the token and, if the validation is successful, the storage control server(s) 204b may interact with the client(s) 202 to effect the transfer (step 528) of the pertinent file(s) 502, as discussed above.

### F. Detailed Description of Example Embodiments of the Compression Technique Recommendation System for Shared Files Introduced in Section A

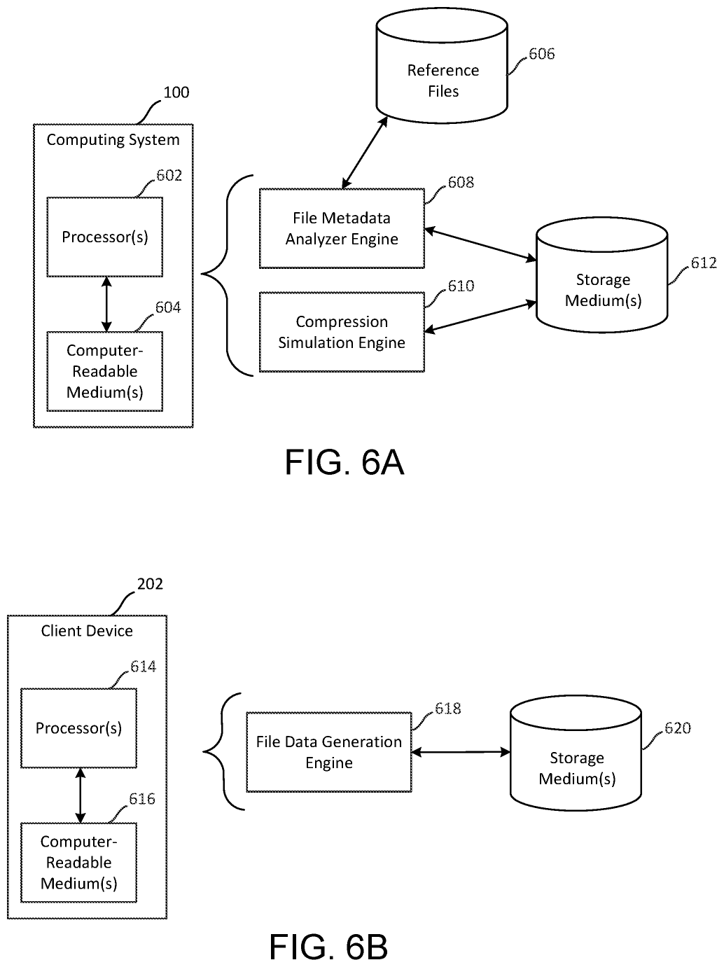

FIG. 6A shows example components of the computing system 100 that may be used to implement at least some of the functionality described above in Section A. As shown, the computing system 100 may include one or more processors 602, one or more computer-readable mediums 604 that are encoded with instructions to be executed by the processor(s) 602, and one or more storage mediums 612. In some implementations, such instructions may cause the processor(s) 602 to implement either or both of the functional engines shown in FIG. 6A. As shown, those functional engines may include a file metadata analyzer engine 608 and a compression simulation engine 610. In some implementations, the computing system 100 may be in included within, or may operate in conjunction with, the file sharing system 504 described in Section E.

FIG. 6B shows example components of the client device 202 that may be used to implement at least some of the functionality described above in Section A. As shown, the client device 202 may include one or more processors 614, one or more computer-readable mediums 616 that are encoded with instructions to be executed by the processor(s) 614, and one or more storage mediums 620. In some implementations, such instructions may cause the processor(s) 614 to implement a file data generation engine 618 shown in FIG. 6B.

The processor(s) 602, 614 and computer-readable medium(s) 604, 616, and the respective functional engines 608, 610, 618, embodied by those components, may be disposed at any of a number of locations within a computing network such as the network environment 200 described above (in Section B) in connection with FIG. 2. The storage medium(s) 612, 620 may likewise be disposed at any of a number of locations within such a computing network in a distributed architecture or fashion. In some implementations, for example, the processor(s) 602 and the computer-readable medium(s) 604 embodying one or more such components may be located within one or more of the servers 204 and/or the computing system 300 that are described above (in Sections B and C) in connection with FIGS. 2 and 3, and/or may be located within a cloud computing environment 400 such as that described above (in Section D) in connection with FIG. 4. In some implementations, one or more of the functional engines 608, 610 and/or the storage medium(s) 612 may additionally or alternatively be disposed within, or may operate in conjunction with, one or more components of a file sharing system, such as the file sharing system 504 described above in connection with FIGS. 5A-5C. In some embodiments, for example, the functional engines 608 and 610 may be included within, or may operate in conjunction with, the access management system 506 and/or the storage system 508 described above (in Section E) in connection with FIGS. 5A-5C.

At a high level, the computing system 100 may determine an optimal compression technique for uploading a file to the file sharing system 504 by processing metadata for the file and/or by evaluating a sampling of data from the payload of the file. In some implementations, the computing system 100 may initially evaluate metadata for the file to attempt to identify an optimal compression technique, and may request a sampling of data from the file's payload (for use in running compression simulations) only if a suitable compression technique cannot be identified based on the metadata.

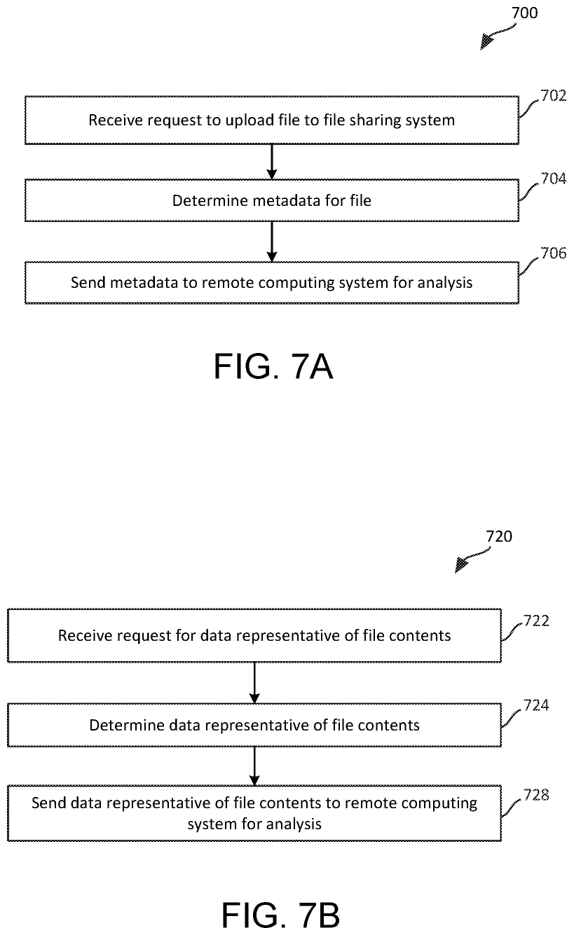

When a user 104 wants to upload a file to the file sharing system 504, the user 104 of the client device 202 may provide an input to a file sharing application (installed or accessed via a web browser). The file management application 513 described in connection with FIG. 5A is an example of such a file sharing application. In response to receiving the input indicating the user 104 wants to upload the file, the file data generation engine 618 (shown in FIG. 6B) may perform an example routine 700, shown in FIG. 7A, to determine metadata (e.g., which may correspond to at least a portion of the data 106 shown in FIG. 1) for the file. The file data generation engine 618 may send the determined metadata to the computing system 100 for use in determining/recommending an optimal compression technique for the file.

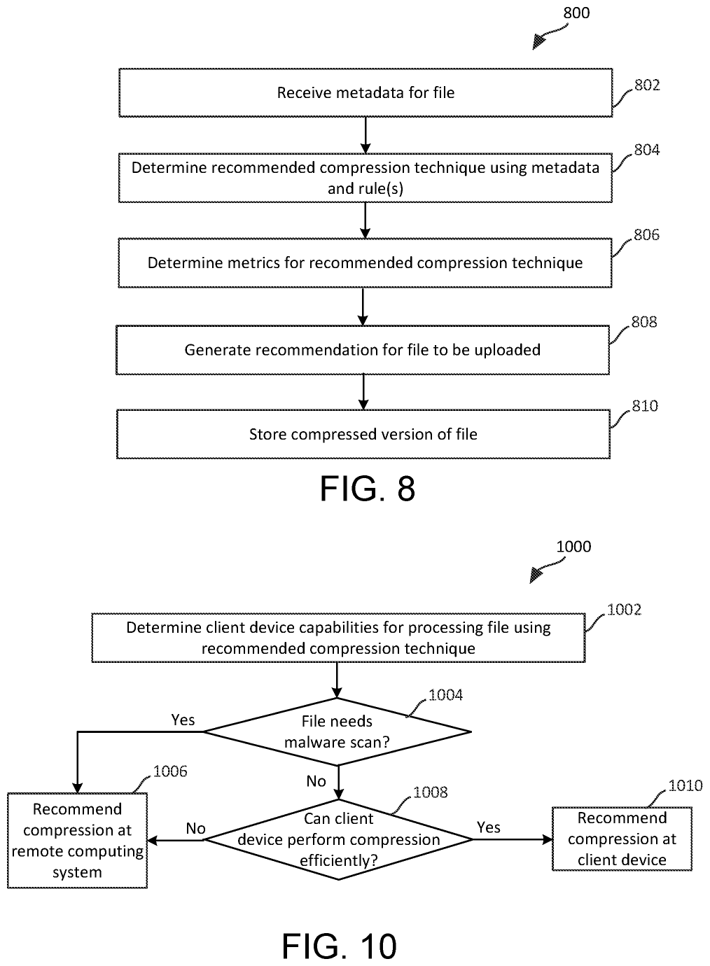

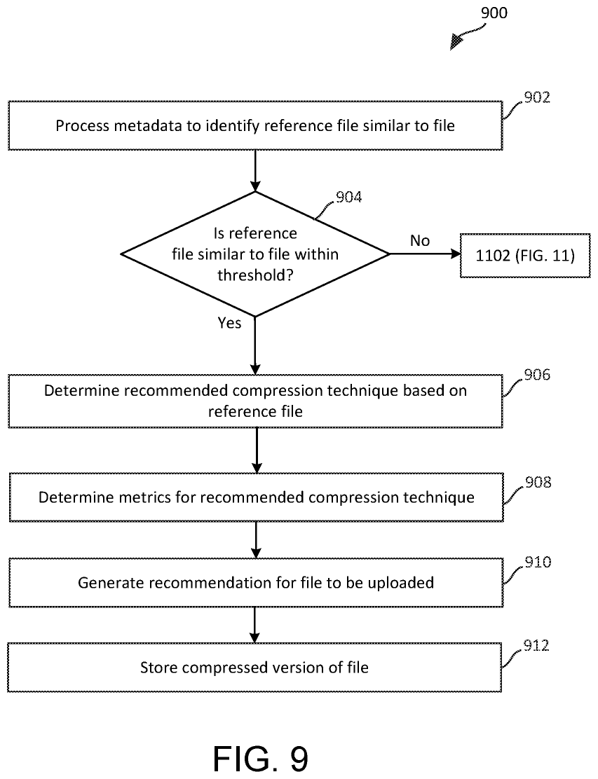

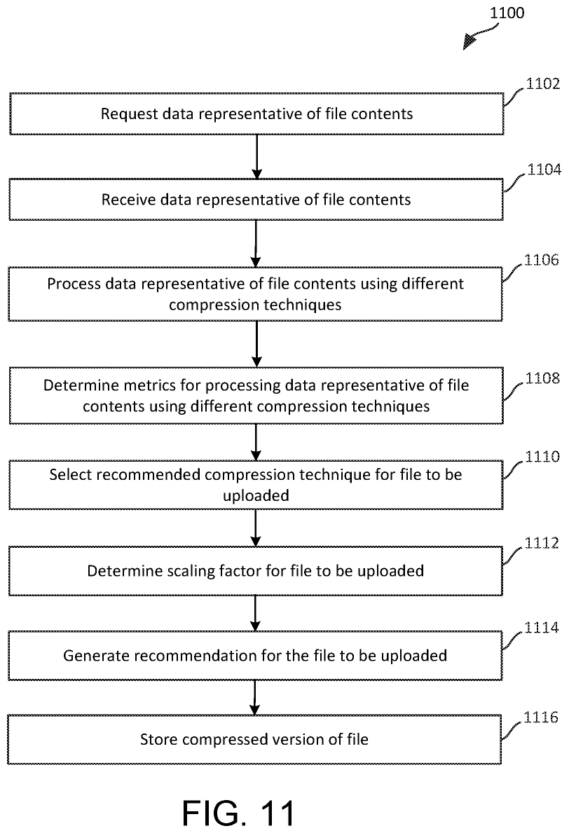

The file metadata analyzer engine 608 (shown in FIG. 6A) of the computing system 100 may perform the example routines 800, 900, 1000 and/or 1000 to determine, based on the metadata received from the file data generation engine 618, an optimal compression technique for the file. The routine 800, shown in FIG. 8, may be performed by the file metadata analyzer engine 608 to determine a recommended compression technique using the metadata and based on one or more rules. The routine 900, shown in FIG. 9, may be performed by the file metadata analyzer engine 608 to determine a recommended compression technique using a reference file similar to the to-be-uploaded file. In some implementations, the file metadata analyzer engine 608 may recommend where the file is to be compressed — at the client device 202 or the computing system 100. The routine 1000, shown in FIG. 10, may be performed by the file metadata analyzer engine 608 to make this recommendation. In some implementations, compression simulation engine 610 of the computing system 100 may additionally or alternatively perform the routine 1100, shown in FIG. 11, to run compression simulations on a sampling of data from the payload of the file to determine a recommended compression technique.

As noted, FIG. 7A shows an example routine 700 that may be performed by the file data generation engine 618 (shown in FIG. 6B) to determine metadata for a file that is to be uploaded to the file sharing system 504. As shown, at a step 702, the file data generation engine 618 may receive a request to upload a file to the file sharing system 504. The user 104 may, for example, provide an input to the file sharing application at the client device 202, where the input may indicate selection of a file stored at the client device 202 for uploading to the file sharing system 504. For example, the file sharing application may display icons representing one or more files, stored at the client device 202 and available for upload, and the user 104 may select one of the displayed files.

At a step 704, the file data generation engine 618 may determine metadata for the file. The metadata may, for example, include tags associated with the file, a filename, a file type, a file size, and/or a username of the user 104. The file data generation engine 618 may determine the metadata using data available at the client device 202 for the file. For example, the file data generation engine 618 may use data available at a file manager application at the client device 202, which may maintain tags and other information for files stored at the client device 202. At a step 706, the file data generation engine 618 may send the metadata to the computing system 100 for analysis.

Further, as noted above, in some implementations, the computing system 100 may request data representative of the contents of the file to be uploaded to the file sharing system 504. The computing system 100 may do so to run simulations using one or more compression techniques, as described below in relation to FIG. 11. FIG. 7B shows an example routine 720 that may be performed by the file data generation engine 618 to determine the data representative of the contents of the file that is to be uploaded to the file sharing system 504. As shown in FIG. 7B, at a step 722, the file data generation engine 618 may receive a request for data representative of the contents of the file.

At a step 724, the file data generation engine 618 may determine the data representative of the contents of the file. The file data generation engine 618 may determine the data representative of the contents of the file to include a portion of the payload of the file. For example, if the file is an audio file, then the data may include a portion (e.g., 10%) of the payload of the audio file. In another example, if the file is a text file, then the data may include a portion of the text. In some embodiments, the data may include a portion of the different types of contents within the file. For example, if the file includes text and images, then the data may include a portion of the text and a portion of the images. In some embodiments, the data representative of the contents of the file may be a hash representation of the entire file contents or a portion of the file contents. At a step 728, the file data generation engine 618 may send the data representative of file contents to the computing system 100 for analysis.

FIG. 8 shows an example routine 800 that may be performed by the file metadata analyzer engine 608 to determine a recommended compression technique for the file using one or more rules. At a step 802, the file metadata analyzer engine 608 may receive the metadata for the file to be uploaded to the file sharing system 504. The received metadata may be the metadata determined by the file data generation engine 618 in the step 704 shown in FIG. 7A.

At a step 804, the file metadata analyzer engine 608 may determine a recommended compression technique using the metadata and one or more rules. The storage medium(s) 612 may store data representing one or more rules for recommending a compression technique. The rules may, for example, indicate a particular compression technique based on a file type. Alternatively or additionally, the rules may indicate a particular compression technique based on a file size. Alternatively or additionally, the rules may indicate a particular compression technique based on a combination of a file type and a file size. In some implementations the particular file size in the rule may be indicated as a single value (e.g., 8 MB, 1 GB, etc.), and in other implementations the particular file size may be indicated as a range (e.g., less than 8 MB, more than 8 MB, between 8 MB and 10 MB, etc.). The file metadata analyzer engine 608 may determine the recommended compression technique based on the compression technique that matches the file type and/or the file size included in the metadata.

At a step 806, the file metadata analyzer engine 608 may determine metrics for the recommended compression technique. The metrics may be an estimate of one or more results of compressing the file using the recommended compression technique. The metrics may, for example, include an estimated amount of time it will take to process the file using the recommended compression technique to determine a compressed version of the file. The file metadata analyzer engine 608 may determine the estimated amount of time based on the file size and using some reference data related to the recommended compression technique. The metrics may also or alternatively include an estimated reduction in file size if the file is compressed using the recommended compression technique. The estimated reduction in file size may be indicated as a percentage. The metrics may also or alternatively include an estimated cost savings for storing a compressed version of the file at the file sharing system 504. The estimated cost savings may be based on a monetary cost of storing data in the cloud computing environment under consideration. The metrics may also or alternatively include an estimated cost of compressing the file at the file sharing system 504, which may be based on a monetary cost of processing data in the cloud computing environment under consideration. Such metrics may provide the user 104 or another user, such as an administrator, information regarding one or more benefits related to using the recommended compression technique.

At a step 808, the file metadata analyzer engine 608 may generate a recommendation for the file to be uploaded to the file sharing system 504. The recommendation may include an indication of the recommended compression technique. The recommendation may also include the metrics for using the recommended compression technique to compress the file. In some implementations, the file metadata analyzer engine 608 may generate text data indicating the recommendation. The file metadata analyzer engine 608 may additionally or alternatively generate another type of data indicating the recommendation, such as, image data, icons, or other graphical user interface elements. The computing system 100 may also generate audio or video data indicating the recommendation.

In some implementations, the file metadata analyzer engine 608 may send the text data and/or other data indicating the recommendation to the client device 202 or another computing device (e.g., an administrator's device) for output at the device. The user 104 or an administrator user may approve the recommendation for using the compression technique (e.g., by selecting a GUI element displayed at the device), and the client device 202a or the computing system 100 may generate a compressed version of the file using the recommended compression technique. In other embodiments, the user 104 or the administrator user may take steps to manually generate a compressed version of the file using the recommended compression technique. In some embodiments, the recommendation sent to the client device 202 may be automatically processed by the client device 202, such that user intervention is not required to effect the compression and uploading of the file to the file sharing system 504 in accordance with the recommended compression technique. If the client device 202 generates the compressed version of the file, the client device 202 may send the compressed version to the file sharing system 504 for uploading. At a step 810, the file metadata analyzer engine 608 may instruct the file sharing system 504 to store the compressed version of the file.

FIG. 9 shows an example routine 900 that may be performed by file metadata analyzer engine 608 to determine a recommended compression technique for the file using a reference file. In some implementations, the file metadata analyzer engine 608 may perform the routine 900 instead of the routine 800. In other implementations, the file metadata analyzer engine 608 may perform the routine 900 if the file metadata analyzer engine 608 is unable to determine a recommended compression technique using the rule(s). The computing system 100, via the file metadata analyzer engine 608, may be in wired or wireless communication with a reference files storage 606. The reference files storage 606 may store one or more files and metadata associated with the respective files. The reference files storage 606 may further store indicators of compression techniques that are associated with the respective reference files or that were used to compress the respective reference files. In some implementations, the reference files storage 606 may store compressed versions of the reference files.

At a step 902, the file metadata analyzer engine 608 may process the metadata (determined by the file data generation engine 618 in the step 704 shown in FIG. 7A) to identify a reference file similar to the file that is to be uploaded to the file sharing system 504. The file metadata analyzer engine 608 may, for example, identify the reference file from the reference files storage 606 and/or the storage 512 of the storage system 508 of the file sharing system 504 (described in Section E). In some implementations, the file metadata analyzer engine 608 may compare the metadata for the file to be uploaded to metadata for the reference files. For example, the file metadata analyzer engine 608 may compare the filename for the file, the file type, the file size and/or the username of the user 104 with reference files stored at the file sharing system 504 or the reference files storage 606 to determine one or more reference files that match or are similar to the file that is to be uploaded. Additionally or alternatively, the file metadata analyzer engine 608 may process the metadata for the file to be uploaded using one or more machine learning models to identify one or more reference files that match or are similar to the file that is to be uploaded. In some implementations, the file metadata analyzer engine 608 may different machine learning models to process different information from the metadata for the file to be uploaded. For example, the file metadata analyzer engine 608 may use a first machine learning model to process the file type of the file to be uploaded, a second machine learning model to process the filename of the file to be uploaded, etc.

In some implementations, the file metadata analyzer engine 608 may determine a score (e.g., a probability) indicating how confident the file metadata analyzer engine 608 is that the reference file matches/is similar to the file to be uploaded. In some implementations, the file metadata analyzer engine 608 may determine a score (e.g., a matching score) that indicates how similar the reference file is to the file to be uploaded, for example, how many data points match between the metadata for the file to be uploaded and the metadata for the reference file. For example, a reference file of the same file type, for example an audio file, as the file, may receive a higher score than a reference file that is of a different file type, for example, a text file. In another example, a reference file of the same or similar size as the file may receive a higher score than a reference file that is of a much smaller or larger size than the file.

At a decision step 904, the file metadata analyzer engine 608 may determine whether the reference file is similar to the file to be uploaded within a threshold. The file metadata analyzer engine 608 may make this determination, for example, based on the score corresponding to the reference file and the file that is to be uploaded. For example, if the score exceeds/satisfies a threshold value, then the file metadata analyzer engine 608 may determine that the reference file is similar to the file to be uploaded within the threshold, and may then perform step 906. If the score does not exceed/satisfy the threshold, then the file metadata analyzer engine 608 may determine that the reference file is not similar to the file to be uploaded within the threshold, and may then perform step 1102 of the routine 1100 shown in FIG. 11.

At a step 906, the file metadata analyzer engine 608 may determine a recommended compression technique based on the reference file. The file sharing system 504 or the reference files storage 606 may store information regarding a compression technique that was used to compress the reference file, or that should be used for files that are determined to be similar to it.

At a step 908, the file metadata analyzer engine 608 may determine metrics for the recommended compression technique. The metrics may be similar to the metrics described in relation to the step 806 shown in FIG. 8. For example, the metrics may include an estimated amount of time, an estimated reduction in file size, an estimated cost savings, and/or an estimated cost of compressing the file in the cloud computing environment under consideration.

At a step 910, the file metadata analyzer engine 608 may generate a recommendation for the file to be uploaded. The recommendation may include an indication of the recommended compression techniques and/or an indication of the metrics. The file metadata analyzer engine 608 may determine data similar to the data described in relation to the step 808 shown in FIG. 8.

In some implementations, the file metadata analyzer engine 608 may send data indicating the recommendation to the client device 202 or another computing device (e.g., an administrator's device) for output at the device. The user 104 or an administrator user may approve the recommendation for using the compression technique (e.g., by selecting a GUI element displayed at the device), and the client device 202a or the computing system 100 may generate a compressed version of the file using the recommended compression technique. In other embodiments, the user 104 or the administrator user may take steps to manually generate a compressed version of the file using the recommended compression technique. In some embodiments, the recommendation sent to the client device 202 may be automatically processed by the client device 202, such that user intervention is not required to effect the compression and uploading of the file to the file sharing system 504 in accordance with the recommended compression technique. If the client device 202 generates the compressed version of the file, the client device 202 may send the compressed version to the file sharing system 504 for uploading. At a step 912, the file metadata analyzer engine 608 may instruct the file sharing system 504 to store the compressed version of the file.

In some implementations, the file metadata analyzer engine 608 may also recommend where the file is to be compressed—the client device 202 or the file sharing system 504. The file metadata analyzer engine 608 may determine this recommendation based on processing capabilities of the client device 202, an estimated time to compress the file at the client device 202, an estimated time to compress the file at the file sharing system 504, a monetary cost of compressing the file at the file sharing system 504, and/or a need for running a malware scan on the file. The recommendation, determined by the file metadata analyzer engine 608, may also send an indication of whether the file is to be compressed at the client device 202 or the file sharing system 504.

FIG. 10 shows an example routine 1000 that may be performed by the file metadata analyzer engine 608 to recommend where the file should be compressed. At a step 1002, the file metadata analyzer engine 608 may determine client device 202 capabilities for processing the file using the recommended compression technique. For example, the file metadata analyzer engine 608 may determine one or more computational resources of the client device 202, such as, memory capacity, number of processors, processor type (CPU vs. GPU), etc.

At a decision step 1004, the file metadata analyzer engine 608 may determine whether the file to be uploaded needs a malware scan. The file metadata analyzer engine 608 may determine that the file needs a malware scan based on the metadata for the file, for example, the file type, the file size, and/or the username of the user 104. For example, if files from the user 104 are often scanned for malware, then the file metadata analyzer engine 608 may determine that the file is to be scanned for malware. As another example, if a file from the user 104 included malware in the past, then the file metadata analyzer engine 608 may determine that the file is to be scanned for malware. As another example, if a particular file type is often scanned for malware, or included malware in the past, then the file metadata analyzer engine 608 may determine that the file is to be scanned for malware. The file metadata analyzer engine 608 may also determine that a malware scan of the file is needed based on a location of the user 104 and/or client device 202 (for example, if the location is not a known location for the user 104 such as the user's 104 home or office), based on whether the network(s) 112, 206 are secure, and other factors indicative of a higher likelihood of malicious activity occurring.

If a malware scan of the file is needed, then at a step 1006 the file metadata analyzer engine 608 may recommend compression of the file at the file sharing system 504. The file metadata analyzer engine 608 may do so, for example, based on the malware scan needing to be performed after the file is received at the file sharing system 504 and before the file is compressed and/or uploaded to the file sharing system 504. A malware scan may not be performable on a compressed version of the file. Furthermore, a malware scan may be performed on the file received at the file sharing system 504 to detect any malicious content that may have been added to the file while it is being transferred from the client device 202 to the file sharing system.

If a malware scan of the file is not needed, then at a decision step 1008 the file metadata analyzer engine 608 may determine whether the client device 202 can perform the compression technique efficiently. The file metadata analyzer engine 608 may identify one or more computational resources (e.g., memory, number of processors, processor type (CPU vs. GPU), etc.) needed to run the compression techniques. Based on the client device 202 capabilities (determined at the step 1002) and the computational resources needed to run the compression technique, the file metadata analyzer engine 608 may determine whether client device 202 can perform the compression technique efficiently. In determining whether the client device 202 can perform the compression technique efficiently, the file metadata analyzer engine 608 may determine, for example, whether the client device 202 can perform the compression technique within a particular amount of time and/or using a particular amount of computational resources.

If the file metadata analyzer engine 608 determines that the client device 202 cannot perform the recommended compression technique efficiently, then at the step 1006, the file metadata analyzer engine 608 may recommend compression of the file at the file sharing system 504. If the file metadata analyzer engine 608 determines that the client device 202 can perform the recommended compression technique efficiently, then at a step 1010 the file metadata analyzer engine 608 may recommend compression of the file at the client device 202.

In some implementations, if the file metadata analyzer engine 608 cannot determine a recommended compression technique using rule(s) (according to the routine 800 of FIG. 8) or a reference file (according to the routine 900 of FIG. 9), then the computing system 100 may perform simulations on data representative of the file contents using various compression techniques, to select a recommended compression technique based on such simulations. FIG. 11 shows an example routine 1100 that may be performed by the compression simulation engine 610 for that purpose. The compression simulation engine 610 may select an optimal compression technique, from the different compression techniques that were simulated, based, for example, on the processing time and/or the reduction in size. The compression simulation engine 610 may generate this recommendation, for example, based on the data representative of the file contents being a sampling of data from the payload of the file that the user 104 wants to upload, and based on the simulations indicating how the respective compression techniques are likely to work with respect to the entire file.

At a step 1102, the compression simulation engine 610 may request data representative of the file contents. The client device 202 may determine the data representative of the file contents as described in relation to the step 724 of FIG. 7B, and at a step 1104, the compression simulation engine 610 may receive the data representative of the file contents.

At a step 1106, the compression simulation engine 610 may process the data representative of the file contents using different compression techniques. In some implementations, the storage medium(s) 612 may store data corresponding to multiple different compression techniques. Such data may include a name for the compression technique, and software code/application for performing the compression technique. In some implementations, the data may include a link or other information enabling access to an application for performing the compression technique. The compression simulation engine 610 may process the data representative of the file contents using a first compression technique, and may store first data related to that processing. The compression simulation engine 610 may process the data representative of the file contents using at least a second compression technique, and may store second data related to that processing.

In some implementations, the compression simulation engine 610 may determine a subset of compression techniques, from the multiple different compression techniques stored at the storage medium(s) 612, to run simulations. The compression simulation engine 610 may determine the subset of compression techniques based on the file type and/or the file size for the file to be uploaded. For example, if the file is an audio file, then the compression simulation engine 610 may determine the subset of compression techniques to include compression techniques capable of compressing audio data. In another example, if the file is an image file, then the compression simulation engine 610 may determine the subset of compression techniques to include compression techniques capable of compressing image data.

At a step 1108, the compression simulation engine 610 may determine metrics for processing the data representative of the file contents using the different compression techniques. For example, the compression simulation engine 610 may determine first metrics, using the first data, for processing the data representative of the file contents using the first compression technique, and may determine second metrics, using the second data, for processing the data representative of the file contents using the second compression technique. Such metrics may include an amount of time taken to process the data representative of the file contents using the respective compression technique. Such metrics may also or alternatively include a reduction in size based on applying the respective compression technique to the data representative of the file contents.

At a step 1110, the compression simulation engine 610 may select a recommended compression technique for the file that is to be uploaded. The compression simulation engine 610 may make this selection based on the metrics for the respective compression techniques determined in the step 1108. The compression simulation engine 610, in some implementations, may select the compression technique, as the recommended compression technique, that resulted in the least amount of time taken to process the data representative of the file contents and the most reduction in size. In other implementations, the compression simulation engine 610 may select the compression technique that resulted in the least amount of time taken to process the data representative of the file contents, regardless of the reduction in size. In some implementations, the compression simulation engine 610 may select the compression technique that resulted in the most reduction in size, regardless of the amount of time taken to process the data representative of the file contents.

At a step 1112, the compression simulation engine 610 may determine a scaling factor for the file to be uploaded. The scaling factor may indicate a percentage or ratio of the data representative of the file contents with respect to the entirety of the file to be uploaded. The compression simulation engine 610 may use the scaling factor to determine metrics to include a recommendation as described below.

At a step 1114, the compression simulation engine 610 may generate a recommendation for the file to be uploaded. The recommendation may include an indication of the recommended compression technique (selected at the step 1110). The recommendation may be data similar to the data described in relation to the step 808 of FIG. 8. The recommendation may also include metrics for using the recommended compression technique to compress the file. The metrics, for example, may include an estimated amount of time it may take to process the file using the recommended compression technique to determine a compressed version of the file. The compression simulation engine 610 may determine the estimated amount of time based on the scaling factor and the amount of time taken to process the data representative of the file contents using the recommended compression technique. The metrics may also or alternatively include an estimated reduction in file size if the file is compressed using the recommended compression technique. The compression simulation engine 610 may determine the estimated reduction in file size based on the scaling factor and the reduction in size of the data representative of the file contents. The metrics may also or alternatively include an estimated cost savings for storing a compressed version of the file at the file sharing system 504. The estimated cost savings may be based on a monetary cost of storing data in the cloud computing environment under consideration. The metrics may also or alternatively include an estimated cost of compressing the file at the file sharing system 504, which may be based on a monetary cost of processing data in the cloud computing environment under consideration.

In some implementations, the compression simulation engine 610 may send the data indicating the recommendation to the client device 202 or another computing device (e.g., an administrator's device) for output at the device. The user 104 or an administrator user may approve the recommendation for using the compression technique (e.g., by selecting a GUI element displayed at the device), and the client device 202a or the file sharing system 504 may generate a compressed version of the file using the recommended compression technique. In other embodiments, the user 104 or the administrator user may take steps to manually generate a compressed version of the file using the recommended compression technique. In some embodiments, the recommendation sent to the client device 202 may be automatically processed by the client device 202, such that user intervention is not required to effect the compression and uploading of the file to the file sharing system 504 in accordance with the recommended compression technique. If the client device 202 generates the compressed version of the file, the client device 202 may send the compressed version to the file sharing system 504 for uploading. At a step 1116, the compression simulation engine 610 may instruct the file sharing system 504 to store the compressed version of the file.

In some implementations, the compression simulation engine 610 may additionally perform the routine 1000 of FIG. 10 so as to include a recommendation on whether the recommended compression technique is to be performed at the client device 202 or the file sharing system 504. The compression simulation engine 610 may, for example, perform the routine 1000 sometime before the step 1114 and after the step 1110, once the recommended compression technique has been selected.

In some implementations, the compression simulation engine 610 may periodically update data the compression techniques to be used for simulations. For example, the compression simulation engine 610 may add data for new compression techniques that can be used for simulations. As a further example, the compression simulation engine 610 may update data (e.g., access information for the compression technique, software/application update, etc.) for compression techniques that were used for simulations in the past. As a further example, the compression simulation engine 610 may delete data for compression techniques that are no longer supported or available to run simulations.

Although the description above describes the computing system 100 determining a single recommended compression technique and determine a recommendation including an indication of a single recommended compression technique, it should be understood that the recommendation, generated by the computing system 100 at steps 808 (of FIG. 8), 910 (of FIGS. 9), and 1114 (of FIG. 11) may include more than one recommended compression technique. For example, the computing system 100 may recommend more than one compression technique for the file to be uploaded based on the metadata for the file satisfying more than one rule (in accordance with the routine 800 of FIG. 8). As another example, the computing system 100 may recommend more than one compression technique for the file to be uploaded based on the metadata for the file matching or being similar to more than one reference file (in accordance with the routine 900 of FIG. 9). As yet another example, the computing system 100 may recommend more than one compression technique for the file to be uploaded based on simulations of more than one compression technique resulting in optimal storage metrics for the file (in accordance with the routine 1100 of FIG. 11). The client device 202 may display more than one recommended compression technique, and the user 104 (or an administrator user) may select one of the displayed compression techniques to generate a compressed version of the file for uploading to the file sharing system 504. Alternatively, the client device 202 may select one of the multiple recommended compression techniques automatically, without requiring using intervention to effect such a selection.

In this manner, the computing system 100 may analyze metadata for a file to determine a recommended compression technique using rules and/or reference files. If a recommended compression technique cannot be determined using rules and/or reference files, then the computing system 100 may run simulations, using different compression techniques, on a portion of the file to determine a recommended compression technique.

In some embodiments, the computing system 100 may determine other storage techniques (than using a compression technique) for files to be uploaded to the file sharing system 504, where the storage techniques may reduce the amount of data stored in the cloud computing environment under consideration. In some implementations, the file sharing system 504 may store a reference link for the file to be uploaded, rather than uploading the file, if the file is identical to a file that is already stored at the file sharing system 504. In some other implementations, the computing system 100 may store data representing a difference between the file to be uploaded and a file that is already stored at the file sharing system 504.

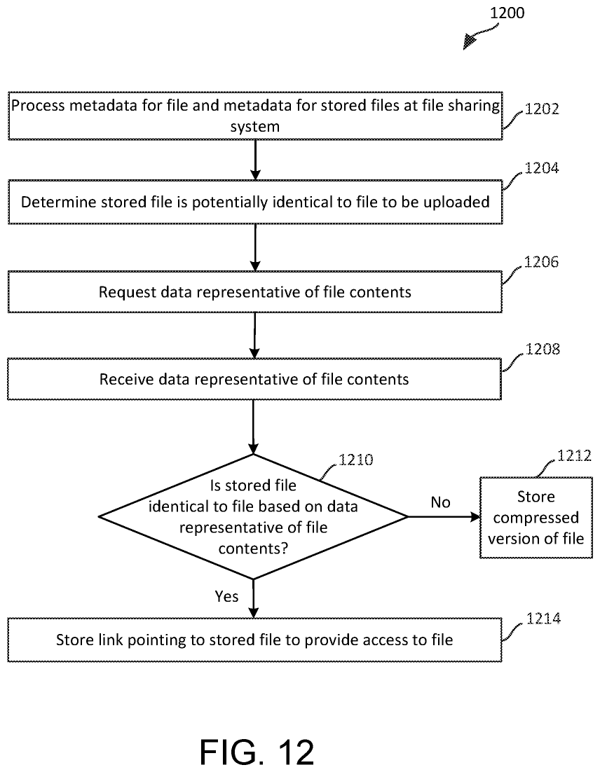

FIG. 12 shows an example routine 1200 that may be performed by the computing system 100 to determine if the file is identical to an already stored file, and storing a link pointing to the stored file. At a step 1202, the computing system 100 may process the metadata for the file (e.g., the metadata determined at the step 704 of FIG. 7A) and metadata for stored files at the file sharing system 504. The stored files (e.g., file 502) may be stored at the storage 512 of the storage system 508 (described in Section E), and the metadata for the stored files may be stored at the storage 510 of the access management system 506 (described in Section E). The metadata for the stored files may include a filename, a file type, a file size, and a username of a user that uploaded the file to the file sharing system 504.

At a step 1204, the computing system 100 may determine that a stored file (of the files stored at the storage 512) is potentially identical to the file to be uploaded. The computing system 100 may make the determination based on certain information in the metadata for the file to be uploaded matching the metadata for the stored file. For example, if the filename, file size and file type of the file to be uploaded is the same as the filename, the file type and file size of the stored file, then the computing system 100 may determine that the stored file is potentially identical to the file to be uploaded.

Based on determining that the stored file is potentially identical to the file to be uploaded, the computing system 100, at a step 1206, may request the data representative of the file contents. The computing system 100 may send the request to the client device 202, the client device 202 may determine the data representative of the file contents as described in relation to the step 724 of FIG. 7B, and the client device 202 may send the data representative of the file contents to the computing system 100 as described in relation to the step 726 of FIG. 7B. At a step 1208, the computing system 100 may receive the data representative of the file contents from the client device 202. The data representative of the file contents may include a portion of the file contents. For example, if the file is an audio file, then the data representative of the file contents may include a portion (10%) of the audio file. In another example, if the file is a text file, then the data representative of the file contents may include a portion of the text. In some embodiments, the data representative of the file contents may include a portion of the different types of contents within the file. For example, if the file includes text and images, then the data representative of the file contents may include a portion of the text and a portion of the images. In some embodiments, the data representative of the file contents may be a hash representation of the entire file contents or a portion of the file contents.

At a decision step 1210, the computing system 100 may determine if the stored file is identical to the file (that the user 104 wants to upload) based on the data representative of the file contents. The computing system 100 may compare the data representative of the file contents to contents of the stored file to determine whether they are identical. In some embodiments, the computing system 100 may compare a hash representation of the contents of the stored file with the data representative of the file contents.

If the stored file is identical to the file to be uploaded, then at a step 1214, the computing system 100 may store a link pointing to the stored file to provide access to the file. In this case, the computing system 100 may store the link to the stored file in the file sharing system 504 instead of uploading the file from the client device 202, so as to save storage costs in the cloud computing environment. The link to the stored file may be stored or provided within a folder in the file sharing system 504 where the user 104 wants to upload the file. When another user (via another client device 202) selects the file for download, the file sharing system 504 may provide the stored file based on the link pointing to the stored file.

If the computing system 100 determines that the stored file is not identical to the file to be uploaded, then at a step 1212, the computing system 100 may store a compressed version of the file. The compressed version of the file may be determined and stored according to one or more steps of the routine 800 (of FIG. 8) and/or the routine 900 (of FIG. 9).

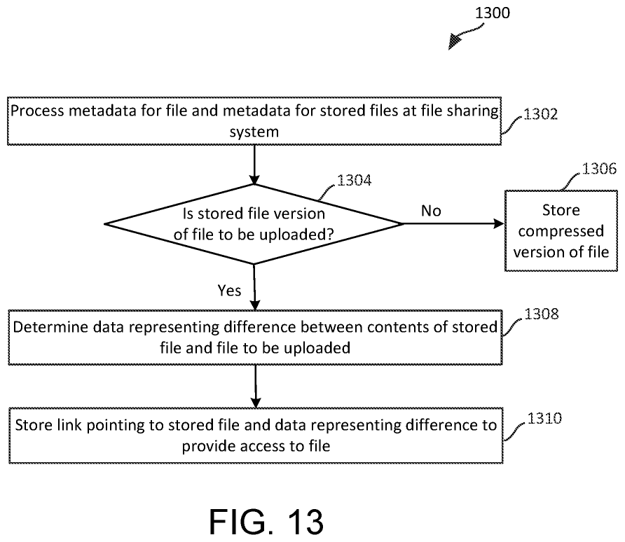

FIG. 13 shows an example routine 1300 that may be performed by the computing system 100 to determine differences between the file to be uploaded and a stored file, and storing data representing the differences. At a step 1302, the computing system 100 may process the metadata for the file (e.g., the metadata determined at the step 704 of FIG. 7A) and metadata for stored files at the file sharing system 504. The stored files (e.g., file 502) may be stored at the storage 512 of the storage system 508 (described in Section E), and the metadata for the stored files may be stored at the storage 510 of the access management system 506 (described in Section E). The metadata for the stored files may include a filename, a file type, a file size, and a username of a user that uploaded the file to the file sharing system 504.

At a decision step 1304, the computing system 100 may determine if a stored file (of the files stored at the storage 512) is a version of the file to be uploaded. The computing system 100 may make this determination based on the metadata for the file to be uploaded matching the metadata for the stored file. For example, if the filename and file type of the file to be uploaded is the same as the filename and the file type of the stored file, then the computing system 100 may determine that the stored file is a version of the file to be uploaded. Additionally, if the username of the user 104, who wants to upload the file, is the same to a username of a user that uploaded the stored file, then the computing system 100 may determine that the stored file is a version of the file to be uploaded. Additionally or alternatively, if usernames of users with whom the file to be uploaded is shared is the same as usernames of users with whom the stored file is shared, then the computing system 100 may determine that the stored file is a version of the file to be uploaded. Additionally or alternatively, the computing system 100 may determine that the file is a version of a stored file based on a folder (within the file sharing system 504) where the user 104 wants to upload the file and a folder where the stored file is stored (e.g., folder information may be stored at storage 510 of the access management system 506). The computing system 100 may additionally or alternatively use other indications to determine that the stored file is a version of the file to be uploaded. For example, an input(s) from the user 104, via the file sharing application at the client device 202, may indicate that the file is a version of the stored file. The computing system 100 may determine that the user 104 downloaded the file from the file sharing system 504, made some changes to the file, and is uploading the modified file (or checking-in the file) to the file sharing system 504.

If the stored file is not a version of the file to be uploaded, then at a step 1306 the computing system 100 may store a compressed version of the file. The compressed version of the file may be determined and stored according to one or more steps of the routine 800 (of FIG. 8) and/or the routine 900 (of FIG. 9).

If the stored file is a version of the file to be uploaded, then at a step 1308, the computing system 100 may determine data representing a difference(s) between the stored file content and the contents of the file to be uploaded. This data may represent any modifications that the user 104 may have made to the stored file or any changes detected by the computing system 100 between the stored file and the file to be uploaded. In some implementations, the data representing the difference(s) may be determined based on a hash representation of the contents of the file to be uploaded and a hash representation of the stored file.

At a step 1310, the computing system 100 may store a link pointing to the stored file and the data representing the difference(s) (between the stored file and the file) to provide access to the file. In this case, the computing system 100 may only store the data representing the differences, rather than storing the entire file, at the file sharing system 504, to reduce the amount of data stored in the cloud. The computing system 100 may store the link and the data representing the differences in a folder indicated by the user 104 where the file is to be uploaded. To provide access to the entire file (e.g., when another user wants to download the file from the file sharing system 504), the file may be determined from the link (pointing to the stored file) and the stored data representing the difference(s).

In some embodiments, the computing system 100 may support storage optimizations for micro deviations (e.g., a small number of differences) between the stored file and the file to be uploaded. The computing system 100 may use a pre-defined threshold value (e.g., an amount of data) to determine when the differences between the stored file and the file to be uploaded are micro deviations. In the case where the changes are micro deviations, the computing system 100 may store data, at the file sharing system 504, in byte sized units, where the units that are the same as the stored file points to corresponding byte sized units of the stored file, and the units that are different from the stored file points to the data from the file to be uploaded.

In some embodiments, the computing system 100 may support storage optimization for macro deviations (e.g., a large number of differences) between the stored file and the file to be uploaded. The computing system 100 may use a pre-defined threshold value (e.g., an amount of data) to determine when the differences between the stored file and the file to be uploaded are macro deviations. In the case where the changes are macro deviations, the computing system 100 may store the link to the stored file along with data representing the differences.

### G. Example Implementations of Methods, Systems, and Computer-Readable Media in Accordance with the Present Disclosure

The following paragraphs (M1) through (M10) describe examples of methods that may be implemented in accordance with the present disclosure.

(M1) A method may involve receiving, by a computing system and from a client device, first data associated with a first file to be uploaded to the computing system, determining, by the computing system and based at least in part on the first data, a recommended compression technique to be used on the first file, sending, from the computing system to the client device, an indication of the recommended compression technique, and receiving, by the computing system and from the client device, a version of the first file that is compressed in accordance with the recommended compression technique.

(M2) A method may be performed as described in paragraph (M1), and may further involve storing, by the computing system, the version of the first file that is compressed in accordance with the recommended compression technique.

(M3) A method may be performed as described in paragraph (M1) or paragraph (M2), and may further involve identifying, by the computing system and based at least in part on the first data, a reference file that is similar to the first file, and determining metadata associated with the identified reference file, wherein determining the recommended compression technique comprises using the metadata to determine the recommended compression technique.

(M4) A method may be performed as described in any of paragraphs (M1) through (M3), and may further involve processing the first data using a first compression technique to yield first compressed data, processing the first data using a second compression technique to yield second compressed data, and selecting the first compression technique as the recommended compression technique based at least in part on a comparison of the first compressed data and the second compressed data.

(M5) A method may be performed as described in paragraph (M4), wherein selecting the first compression technique is based at least in part on a processing time of the first compression technique and a reduction in file size using the first compression technique.

(M6) A method may be performed as described in any of paragraphs (M1) through (M5), and may further involve receiving, by the computing system and from the client device, second data associated with a second file to be uploaded to the computing system, determining, by the computing system and based at least in part on the second data, to recommend not compressing the second file prior to transferring the second file to the computing system, sending, from the computing system to the client device, an indication of the recommendation not to compress the second file, and receiving, by the computing system and from the client device, the second file.

(M7) A method may be performed as described in paragraph (M6), and may further involve compressing, by the computing system, the second file to generate a compressed version of the second file, and storing, by the computing system, the compressed version of the second file.

(M8) A method may be performed as described in paragraph (M6), and may further involve determining, based at least in part upon the second data, that a malware scan of the second file is to be performed, wherein the determination to recommend not compressing the second file is based at least in part on the determination that the malware scan of the second file is to be performed.

(M9) A method may be performed as described in any of paragraphs (M1) through (M8), and may further involve determining, by the computing system, a percentage by which a size of the first file will be reduced using the recommended compression technique, wherein the indication further includes the percentage.

(M10) A method may be performed as described in any of paragraphs (M1) through (M9), and may further involve determining, by the computing system, a computational cost for using the recommended compression technique on the first file, determining, based on the computational cost, that the client device has a computational capability to perform the recommended compression technique, and determining, by the computing system, that the recommended compression technique is to be applied to the first file before the first file is transferred to the computing system.

The following paragraphs (S1) through (S10) describe examples of systems and devices that may be implemented in accordance with the present disclosure.

(S1) A computing system may comprise at least one processor and at least one computer-readable medium encoded with instructions which, when executed by the at least one processor, cause the computing system to receive, from a client device, first data associated with a first file to be uploaded to the computing system, determine, based at least in part on the first data, a recommended compression technique to be used on the first file, send, to the client device, an indication of the recommended compression technique, and receive, from the client device, a version of the first file that is compressed in accordance with the recommended compression technique.

(S2) A computing system may be configured as described in paragraph (S1), and the at least one computer-readable medium may be encoded with additional instruction which, when executed by the at least one processor, further cause the computing system to store the version of the first file that is compressed in accordance with the recommended compression technique.

(S3) A computing system may be configured as described in paragraph (S1) or paragraph (S2), and the at least one computer-readable medium may be encoded with additional instruction which, when executed by the at least one processor, further cause the computing system to identify, based at least in part on the first data, a reference file that is similar to the first file, determine metadata associated with the identified reference file, and determine the recommended compression technique using the metadata.

(S4) A computing system may be configured as described in any of paragraphs (S1) through (S3), and the at least one computer-readable medium may be encoded with additional instruction which, when executed by the at least one processor, further cause the computing system to process the first data using a first compression technique to yield first compressed data, process the first data using a second compression technique to yield second compressed data, and select the first compression technique as the recommended compression technique based at least in part on a comparison of the first compressed data and the second compressed data.

(S5) A computing system may be configured as described in paragraph (S4), wherein selection of the first compression technique is based at least in part on a processing time of the first compression technique and a reduction in file size using the first compression technique.

(S6) A computing system may be configured as described in any of paragraphs (S1) through (S5), and the at least one computer-readable medium may be encoded with additional instruction which, when executed by the at least one processor, further cause the computing system to receive, from the client device, second data associated with a second file to be uploaded to the computing system, determine, based at least in part on the second data, to recommend not compressing the second file prior to transferring the second file to the computing system, send, to the client device, an indication of the recommendation not to compress the second file, and receive, from the client device, the second file.

(S7) A computing system may be configured as described in paragraph (S6), and the at least one computer-readable medium may be encoded with additional instruction which, when executed by the at least one processor, further cause the computing system to compress the second file to generate a compressed version of the second file, and store the compressed version of the second file.

(S8) A computing system may be configured as described in paragraph (S6), and the at least one computer-readable medium may be encoded with additional instruction which, when executed by the at least one processor, further cause the computing system to determine, based at least in part upon the second data, that a malware scan of the second file is to be performed, wherein the determination to recommend not compressing the second file is based at least in part on the determination that the malware scan of the second file is to be performed.

(S9) A computing system may be configured as described in any of paragraphs (S1) through (S8), and the at least one computer-readable medium may be encoded with additional instruction which, when executed by the at least one processor, further cause the computing system to determine a percentage by which a size of the first file will be reduced using the recommended compression technique, and wherein the indication further includes the percentage.

(S10) A computing system may be configured as described in any of paragraphs (S1) through (S9), and the at least one computer-readable medium may be encoded with additional instruction which, when executed by the at least one processor, further cause the computing system to determine a computational cost for using the recommended compression technique on the first file, determine, based on the computational cost, that the client device has a computational capability to perform the recommended compression technique, and determine that the recommended compression technique is to be applied to the first file before the first file is transferred to the computing system.

The following paragraphs (CRM1) through (CRM10) describe examples of computer-readable media that may be implemented in accordance with the present disclosure.

(CRM1) At least one non-transitory computer-readable medium may be encoded with instructions which, when executed by at least one processor included in a computing system, cause the computing system to receive, from a client device, first data associated with a first file to be uploaded to the computing system, determine, based at least in part on the first data, a recommended compression technique to be used on the first file, send, to the client device, an indication of the recommended compression technique, and receive, from the client device, a version of the first file that is compressed in accordance with the recommended compression technique.

(CRM2) At least one non-transitory computer-readable medium may be configured as described in paragraph (CRM1), and may be encoded with additional instruction which, when executed by the at least one processor, further cause the computing system to store the version of the first file that is compressed in accordance with the recommended compression technique.

(CRM3) At least one non-transitory computer-readable medium may be configured as described in paragraph (CRM1) or paragraph (CRM2), and may be encoded with additional instruction which, when executed by the at least one processor, further cause the computing system to identify, based at least in part on the first data, a reference file that is similar to the first file, determine metadata associated with the identified reference file, and determine the recommended compression technique using the metadata.

(CRM4) At least one non-transitory computer-readable medium may be configured as described in any of paragraphs (CRM1) through (CRM3), and may be encoded with additional instruction which, when executed by the at least one processor, further cause the computing system to process the first data using a first compression technique to yield first compressed data, process the first data using a second compression technique to yield second compressed data, and select the first compression technique as the recommended compression technique based at least in part on a comparison of the first compressed data and the second compressed data.

(CRM5) At least one non-transitory computer-readable medium may be configured as described in paragraph (CRM4), wherein selection of the first compression technique is based at least in part on a processing time of the first compression technique and a reduction in file size using the first compression technique.

(CRM6) At least one non-transitory computer-readable medium may be configured as described in any of paragraphs (CRM1) through (CRM5), and may be encoded with additional instruction which, when executed by the at least one processor, further cause the computing system to receive, from the client device, second data associated with a second file to be uploaded to the computing system, determine, based at least in part on the second data, to recommend not compressing the second file prior to transferring the second file to the computing system, send, to the client device, an indication of the recommendation not to compress the second file, and receive, from the client device, the second file.

(CRM7) At least one non-transitory computer-readable medium may be configured as described in paragraph (CRM6), and may be encoded with additional instruction which, when executed by the at least one processor, further cause the computing system to compress the second file to generate a compressed version of the second file, and store the compressed version of the second file.

(CRM8) At least one non-transitory computer-readable medium may be configured as described in paragraph (CRM6), and may be encoded with additional instruction which, when executed by the at least one processor, further cause the computing system to determine, based at least in part upon the second data, that a malware scan of the second file is to be performed, wherein the determination to recommend not compressing the second file is based at least in part on the determination that the malware scan of the second file is to be performed.

(CRM9) At least one non-transitory computer-readable medium may be configured as described in any of paragraphs (CRM1) through (CRM8), and may be encoded with additional instruction which, when executed by the at least one processor, further cause the computing system to determine a percentage by which a size of the first file will be reduced using the recommended compression technique, and wherein the indication further includes the percentage.

(CRM10) At least one non-transitory computer-readable medium may be configured as described in any of paragraphs (CRM1) through (CRM9), and may be encoded with additional instruction which, when executed by the at least one processor, further cause the computing system to determine a computational cost for using the recommended compression technique on the first file, determine, based on the computational cost, that the client device has a computational capability to perform the recommended compression technique, and determine that the recommended compression technique is to be applied to the first file before the first file is transferred to the computing system.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, by a computing system and from a client device, first data associated with a first file to be uploaded to the computing system;
determining, by the computing system and based at least in part on the first data, a recommended compression technique to be used on the first file;
sending, from the computing system to the client device, an indication of the recommended compression technique; and
receiving, by the computing system and from the client device, a version of the first file that is compressed in accordance with the recommended compression technique.

2. The method of claim 1, further comprising:
storing, by the computing system, the version of the first file that is compressed in accordance with the recommended compression technique.

3. The method of claim 1, further comprising:
identifying, by the computing system and based at least in part on the first data, a reference file that is similar to the first file; and
determining metadata associated with the identified reference file;
wherein determining the recommended compression technique comprises using the metadata to determine the recommended compression technique.

4. The method of claims 1, further comprising:
processing the first data using a first compression technique to yield first compressed data;
processing the first data using a second compression technique to yield second compressed data; and
selecting the first compression technique as the recommended compression technique based at least in part on a comparison of the first compressed data and the second compressed data.

5. The method of claim 4, wherein selecting the first compression technique is based at least in part on a processing time of the first compression technique and a reduction in file size using the first compression technique.

6. The method of claim 1, further comprising:
receiving, by the computing system and from the client device, second data associated with a second file to be uploaded to the computing system;
determining, by the computing system and based at least in part on the second data, to recommend not compressing the second file prior to transferring the second file to the computing system;
sending, from the computing system to the client device, an indication of the recommendation not to compress the second file; and
receiving, by the computing system and from the client device, the second file. The method of claim 6, further comprising:
compressing, by the computing system, the second file to generate a compressed version of the second file; and
storing, by the computing system, the compressed version of the second file.

8. The method of claim 6, further comprising:
determining, based at least in part upon the second data, that a malware scan of the second file is to be performed;
wherein the determination to recommend not compressing the second file is based at least in part on the determination that the malware scan of the second file is to be performed.

9. The method of claim 1, further comprising:
determining, by the computing system, a percentage by which a size of the first file will be reduced using the recommended compression technique,
wherein the indication further includes the percentage.

10. The method of claim 1, further comprising:
determining, by the computing system, a computational cost for using the recommended compression technique on the first file;
determining, based on the computational cost, that the client device has a computational capability to perform the recommended compression technique; and
determining, by the computing system, that the recommended compression technique is to be applied to the first file before the first file is transferred to the computing system.

11. A computing system comprising:
at least one processor; and
at least one computer-readable medium encoded with instructions which, when executed by the at least one processor, cause the computing system to:
receive, from a client device, first data associated with a first file to be uploaded to the computing system;
determine, based at least in part on the first data, a recommended compression technique to be used on the first file;
send, to the client device, an indication of the recommended compression technique; and
receive, from the client device, a version of the first file that is compressed in accordance with the recommended compression technique.

12. The computing system of claim 11, wherein the at least one computer-readable medium is encoded with additional instructions which, when executed by the at least one processor, further cause the computing system to:
store the version of the first file that is compressed in accordance with the recommended compression technique.

13. The computing system of claim 11, wherein the at least one computer-readable medium is encoded with additional instructions which, when executed by the at least one processor, further cause the computing system to:
identify, based at least in part on the first data, a reference file that is similar to the first file;
determine metadata associated with the identified reference file; and
determine the recommended compression technique using the metadata.

14. The computing system of claim 11, wherein the at least one computer-readable medium is encoded with additional instructions which, when executed by the at least one processor, further cause the computing system to:
process the first data using a first compression technique to yield first compressed data;
process the first data using a second compression technique to yield second compressed data; and
select the first compression technique as the recommended compression technique based at least in part on a comparison of the first compressed data and the second compressed data.

15. The computing system of claim 14, wherein selection of the first compression technique is based at least in part on a processing time of the first compression technique and a reduction in file size using the first compression technique.

16. The computing system of claim 11, wherein the at least one computer-readable medium is encoded with additional instructions which, when executed by the at least one processor, further cause the computing system to:
receive, from the client device, second data associated with a second file to be uploaded to the computing system;
determine, based at least in part on the second data, to recommend not compressing the second file prior to transferring the second file to the computing system;
send, to the client device, an indication of the recommendation not to compress the second file; and
receive, from the client device, the second file.

17. The computing system of claim 16, wherein the at least one computer-readable medium is encoded with additional instructions which, when executed by the at least one processor, further cause the computing system to:
compress the second file to generate a compressed version of the second file; and
store the compressed version of the second file.

18. The computing system of claim 16, wherein the at least one computer-readable medium is encoded with additional instructions which, when executed by the at least one processor, further cause the computing system to:
determine, based at least in part upon the second data, that a malware scan of the second file is to be performed;
wherein the determination to recommend not compressing the second file is based at least in part on the determination that the malware scan of the second file is to be performed.

19. The computing system of claim 11, wherein the at least one computer-readable medium is encoded with additional instructions which, when executed by the at least one processor, further cause the computing system to:
determine a percentage by which a size of the first file will be reduced using the recommended compression technique, and
wherein the indication further includes the percentage.

20. At least one non-transitory computer-readable medium encoded with instructions which, when executed by at least one processor of a computing system, cause the computing system to:
receive, from a client device, first data associated with a first file to be uploaded to the computing system;
determine, based at least in part on the first data, a recommended compression technique to be used on the first file;
send, to the client device, an indication of the recommended compression technique; and
receive, from the client device, a version of the first file that is compressed in accordance with the recommended compression technique.
